(19) United States
(12) Patent Application Publication
(10) Pub. No.: US 2026/0257331 A1
(43) Pub. Date: Sep. 3, 2026

(54) ELEVATOR DOOR MAINTENANCE DEVICE

(71) Applicant: Ray Harding, Las Vegas, NV (US)

(72) Inventor: Ray Harding, Las Vegas, NV (US)

(21) Appl. No.: 19/068,533

(22) Filed: Mar. 3, 2025

(51) Int. Cl. B25F 1/02; B25G 1/08

(52) U.S. Cl. CPC B25F 1/02; B25G 1/08

(57) ABSTRACT

An elevator door maintenance device includes a handle, a door key, and an elevator maintenance tool. The handle is elongated and includes a front wall, a rear wall, and a perimeter wall connecting the front wall and the rear wall. The handle also includes a receptacle. The door key is attached to the handle and projecting from the front wall. The door key is designed to open an elevator door. An elevator maintenance tool is removably stored in the receptacle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to elevator door tools and more particularly pertains to a new elevator door maintenance device for carrying all essential tools for elevator maintenance. For elevator maintenance, a primary tool is the door key. Secondary tools are also needed, such as door wedge tools, flashlights, pens, markers, and screwdrivers, to perform various tasks. An elevator maintenance technician always remembers to bring the door key to the job site, but often can forget the secondary tools, thereby wasting time and effort in retrieving such forgotten secondary tools. The new elevator door maintenance device includes the primary and secondary tools in a single device for convenience and increased productivity.

### (2) Description of Related Art including information disclosed under 37 CFR 1.97 and 1.98

The prior art relates to multi-function tools, and includes an elevator door key tool that has the three main types of elevator door keys, namely, flat, moon, and drop style. The prior art, as best understood, does not disclose an elevator door maintenance device that has a handle, a door key, and an elevator maintenance tool. The handle includes a receptacle, and the elevator maintenance tool is removably stored in the receptacle. The handle can include multiple receptacles for multiple elevator maintenance tools of different types.

### BRIEF SUMMARY OF THE INVENTION

An embodiment of the disclosure meets the needs presented above in an elevator door maintenance device generally comprising a handle, a door key, and an elevator maintenance tool. The handle is elongated and includes a front wall, a rear wall, and a perimeter wall connecting the front wall and the rear wall. The handle also includes a receptacle. The door key is attached to the handle and projecting from the front wall. The door key is designed to open an elevator door. An elevator maintenance tool is removably stored in the receptacle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a first embodiment of an elevator door maintenance device according to an embodiment of the disclosure.

FIG. 2 is a partially exploded perspective view of the first embodiment of the disclosure.

FIG. 3 is a perspective view of components of the first embodiment of the disclosure.

FIG. 4 is a side view of the first embodiment of the disclosure in use.

FIG. 5 is a partially exploded perspective view of a second embodiment of the disclosure.

FIG. 6 is a perspective view of a third embodiment of the disclosure.

FIG. 7 is an exploded perspective view of the third embodiment of the disclosure.

FIG. 8 is a perspective view of a fourth embodiment of the disclosure.

FIG. 9 is an exploded perspective view of the fourth embodiment of the disclosure.

### DETAILED DESCRIPTION OF THE INVENTION

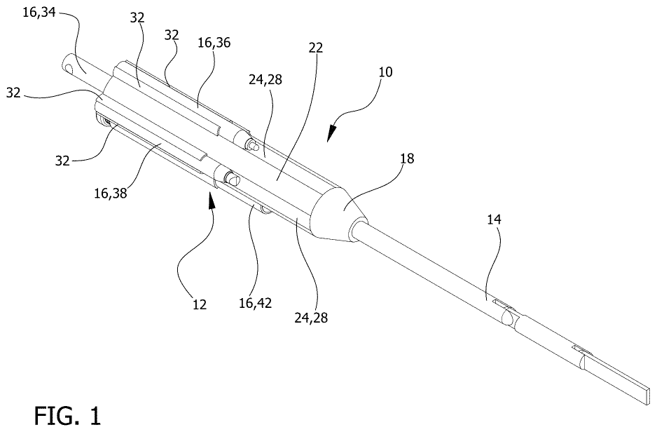

With reference now to the drawings, and in particular to FIGS. 1 through 9 thereof, a new elevator door maintenance device embodying the principles and concepts of an embodiment of the disclosure and generally designated by the reference numeral 10 will be described.

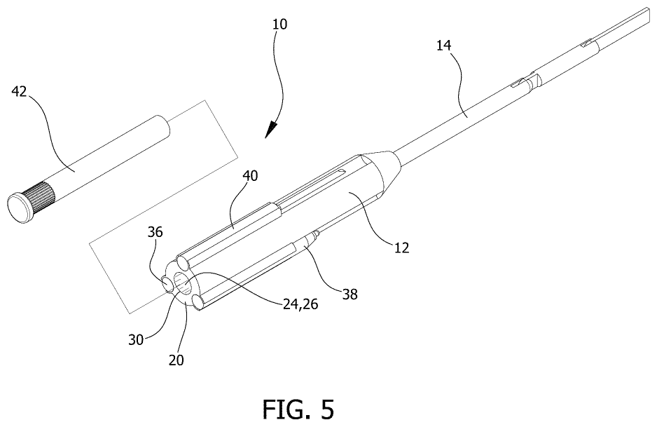

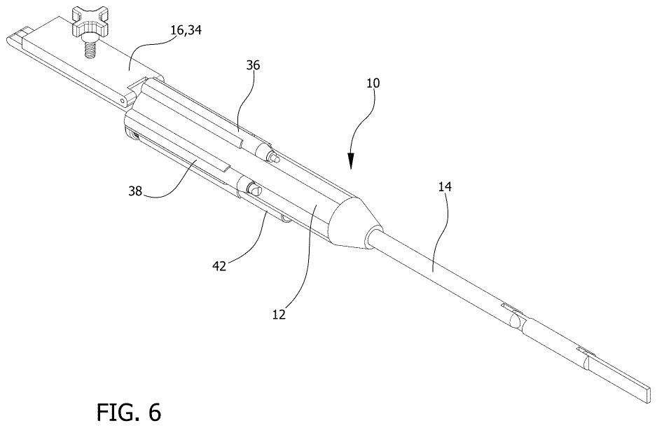

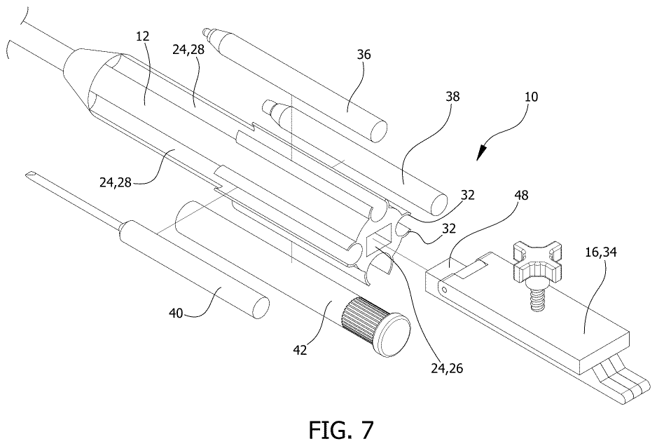

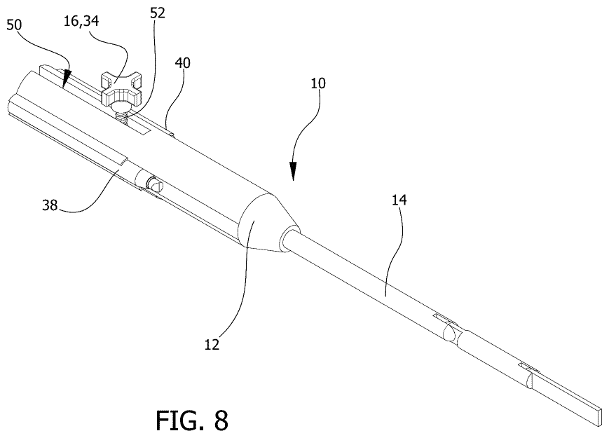

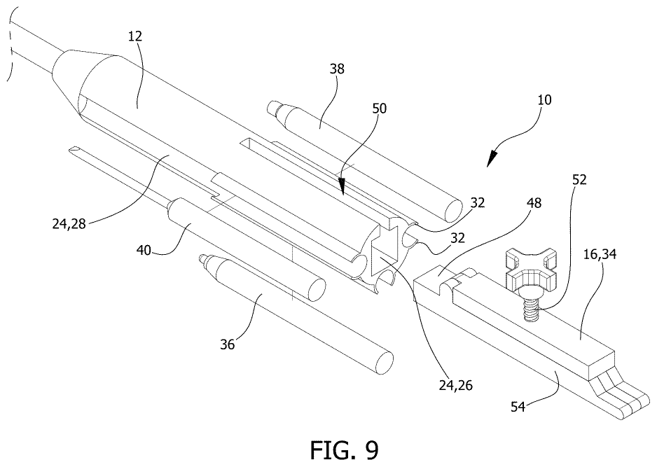

It should first be noted that FIGS. 1 through 4 show a first embodiment of the elevator door maintenance device 10, FIG. 5 shows a second embodiment of the elevator door maintenance device 10, FIGS. 6 and 7 show a third embodiment of the elevator door maintenance device 10, and FIGS. 8 and 9 show a fourth embodiment of the elevator door maintenance device 10. Components common to all three embodiments utilize the same reference numbers. It should be noted that these are exemplary embodiments and other configurations and arrangements of components are within the scope of the disclosure.

In all embodiments, the elevator door maintenance device 10 comprises a handle 12, a door key 14, and an elevator maintenance tool 16. The handle 12 is elongated and includes a front wall 18, a rear wall 20, and a perimeter wall 22 connecting the front wall 18 and the rear wall 20. The handle 12 also includes a receptacle 24. The door key 14 is attached to the handle 12 and projecting from the front wall 18. The door key 14 is designed to open an elevator door. An elevator maintenance tool 16 is removably stored in the receptacle 24.

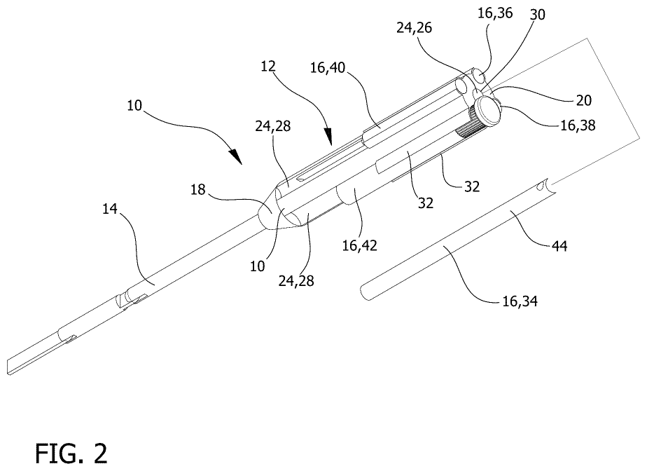

In all embodiments, the elevator door maintenance device 10 includes a plurality of the elevator maintenance tools 16 and a plurality of the receptacles 24. However, in one possible embodiment, there could be only one elevator maintenance tool 16 and only one respective receptacle 24. This single receptacle 24 could be either a chamber 26 or a groove 28, each designed to receive and store a portion of the elevator maintenance tool 16. The chamber 26 is shown in FIG. 2, for example, wherein the chamber 26 is positioned within the handle 12 and is open at an aperture 30 in the rear wall 20. The groove 28 is best seen in FIG. 7, wherein the groove 28 is elongated and formed in the perimeter wall 22. As also shown in FIG. 7, a pair of brackets 32 projects from opposing side edges of the groove 28. Each of the brackets 32 is curved and resiliently flexible. Therefore, while each of the embodiments show the chamber 26 and a plurality of the grooves 28 with respective brackets 32, in one possible embodiment there could be only one receptacle 24, either the chamber 26 or the groove 28. In another possible embodiment there could be only two receptacles 24, namely the chamber 26 and one groove 28, or possibly two grooves 28 and no chamber 26, or possibly two chambers 26 and no groove 28. In one possible embodiment, the grooves 28 could be designed such that the brackets 32 are not required and thus omitted. It should be understood that essentially any configuration of one or more receptacles 24 being chambers 26 or grooves 28 is within the scope of the disclosure. However, the following description will be in reference to the exemplary embodiments shown in the drawings.

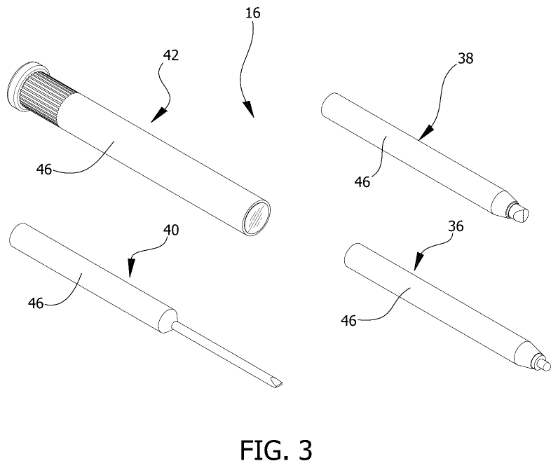

With reference to the first embodiment in FIGS. 1 through 4, the handle 12 includes the chamber 26, a plurality of the grooves 28, and a respective plurality of pairs of the brackets 32. The elevator maintenance tools 16 include a door wedge tool 34, two writing implements, namely a pen 36 and a marker 38, a screwdriver 40, and a flashlight 42. Again, this is an exemplary embodiment, and fewer elevator maintenance tools 16 could be included in other possible embodiments. For example, there could be only one writing implement, which could be the pen 36, the marker 38, or possibly another type of the writing implement. As shown in FIG. 2, the door wedge tool 34 has a cylindrical body 44. The chamber 26 is cylindrical to receive the cylindrical body 44 of the door wedge tool 34. Each one of the pen 36, the marker 38, the screwdriver 40, and the flashlight 42 also has a cylindrical body 46. Each of the grooves 28 is rounded to receive a portion of the cylindrical body 46. FIG. 3 shows each of these elevator maintenance tools 16 removed from the elevator door maintenance device 10.

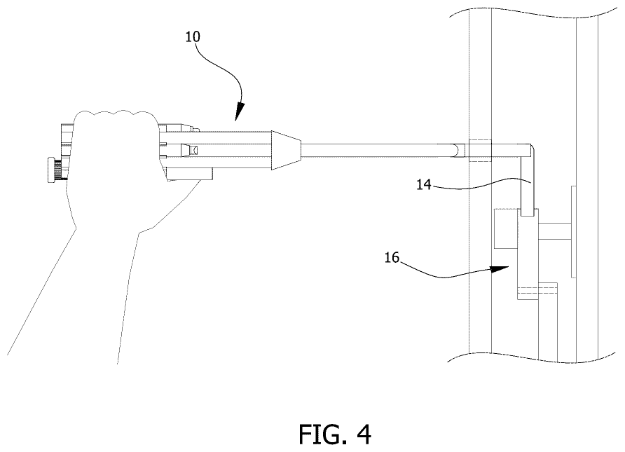

The door key 14 shown in FIGS. 1 through 4 is a drop key. However, any type of door key 14, such as a moon or lunar key or a barrel key, could be included in the elevator door maintenance device 10. FIG. 4 shows the use of the drop-style door key 14 to open an elevator door lock mechanism 60. The user can use the other elevator maintenance tools 16 shown in FIG. 3 to perform other tasks, such as locking the elevator door open with the door wedge tool 34 or looking into dark areas with the flashlight 42.

In the second embodiment in FIG. 5, the door wedge tool 34 has been omitted and the flashlight 42 is stored in the chamber 26. This embodiment also includes the pen 36, the marker 38, and the screwdriver 40, but only has three respective grooves 28, unlike the four grooves 28 in the first embodiment.

In the third embodiment in FIGS. 6 and 7, the elevator door maintenance device 10 has a different type of the door wedge tool 34, which in this case has a rectangular portion 48. As shown in FIG. 7, the chamber 26 is rectangular to receive the rectangular portion 48 of the door wedge tool 34. Like the first embodiment, this third embodiment also includes the pen 36, the marker 38, the screwdriver 40, and the flashlight 42.

In the fourth embodiment in FIGS. 8 and 9, the elevator door maintenance device 10 is designed much like the third embodiment in FIGS. 6 and 7, but the door wedge tool 34 has a body 54 with a much narrower profile or size. The chamber 26 is designed to receive the entirety of the body 54 of the door wedge tool 34. However, the door wedge tool 34 also includes an adjustment screw 52 projecting from the body 54, which would block insertion of the door wedge tool 34 into the chamber 26. Therefore, as shown in FIG. 9, the handle 12 includes a slot 50 in the perimeter wall 22 and extending into the rear wall 20 such that, as shown in FIG. 8, the adjustment screw 52 projects through the slot 50 and out of the handle 12 when the door wedge tool 34 is inserted into the chamber 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An elevator door maintenance device comprising:
a handle being elongated and including a front wall, a rear wall, and a perimeter wall connecting said front wall and said rear wall, said handle including a receptacle;
a door key being attached to said handle and projecting from said front wall, said door key being configured to open an elevator door; and
an elevator maintenance tool being removably stored in said receptacle.

2. The elevator door maintenance device of claim 1, wherein:
said receptacle is a chamber within said handle that is open at an aperture in said rear wall; and
said chamber is configured to receive and store a portion of said elevator maintenance tool.

3. The elevator door maintenance device of claim 2, wherein:
said elevator maintenance tool has a cylindrical body; and
said chamber is cylindrical to receive said cylindrical body.

4. The elevator door maintenance device of claim 3, wherein said elevator maintenance tool is a flashlight.

5. The elevator door maintenance device of claim 3, wherein said elevator maintenance tool is a door wedge tool.

6. The elevator door maintenance device of claim 2, wherein:
said elevator maintenance tool is a door wedge tool having a rectangular portion; and
said chamber is rectangular to receive said rectangular portion of said door wedge tool.

7. The elevator door maintenance device of claim 6, wherein:
said door wedge tool includes a body and an adjustment screw projecting from said body;
said chamber is configured to receive the entirety of said body of said door wedge tool; and
said handle includes a slot in said perimeter wall and extending into said rear wall such that said adjustment screw projects through said slot and out of said handle when said door wedge tool is inserted into said chamber.

8. The elevator door maintenance device of claim 1, wherein:
said receptacle is a groove that is elongated and formed in said perimeter wall; and
said groove is configured to receive and store a portion of said elevator maintenance tool.

9. The elevator door maintenance device of claim 8, wherein:
said elevator maintenance tool has a cylindrical body; and
said groove is rounded to receive a portion of said cylindrical body.

10. The elevator door maintenance device of claim 9, wherein said elevator maintenance tool is a writing implement.

11. The elevator door maintenance device of claim 9, wherein said elevator maintenance tool is a flashlight.

12. The elevator door maintenance device of claim 9, wherein said elevator maintenance tool is a screwdriver.

13. The elevator door maintenance device of claim 9, further including a pair of brackets projecting from opposing side edges of said groove, each of said brackets being curved and resiliently flexible.

14. The elevator door maintenance device of claim 13, wherein said elevator maintenance tool is one of: a writing implement, a flashlight, and a screwdriver.

15. The elevator door maintenance device of claim 1, wherein said door key is a drop key.

16. The elevator door maintenance device of claim 1, further including a plurality of said receptacles and a plurality of said elevator maintenance tools, wherein:
said elevator maintenance tools include a first elevator maintenance tool and a second elevator maintenance tool different from said first elevator maintenance tool;
said receptacles include a chamber within said handle that is open at an aperture in said rear wall;
said chamber is configured to receive and store a portion of said first elevator maintenance tool;
said receptacles include a groove that is elongated and formed in said perimeter wall; and
said groove is configured to receive and store a portion of said second elevator maintenance tool.

17. The elevator door maintenance device of claim 16, wherein:
said second elevator maintenance tool has a cylindrical body;
said groove is rounded to receive a portion of said cylindrical body;
the elevator door maintenance device further includes a pair of brackets projecting from opposing side edges of said groove;
each of said brackets is curved and resiliently flexible; and
said door key is a drop key.

18. The elevator door maintenance device of claim 17, further including a plurality of said second elevator maintenance tools, a respective plurality of said grooves, and a respective plurality of pairs of said brackets, wherein:
said second elevator maintenance tools include a writing implement and a screwdriver; and
said first elevator maintenance tool is one of a flashlight and a door wedge tool.

19. The elevator door maintenance device of claim 17, further including a plurality of said second elevator maintenance tools, a respective plurality of said grooves, and a respective plurality of pairs of said brackets, wherein:
said first elevator maintenance tool is a door wedge tool having a cylindrical body;
said chamber is cylindrical to receive said cylindrical body of said door wedge tool; and
said second elevator maintenance tools include each of a pen, a marker, a screwdriver, and a flashlight.

20. The elevator door maintenance device of claim 17, further including a plurality of said second elevator maintenance tools, a plurality of said grooves, and a plurality of respective pairs of said brackets, wherein:
said first elevator maintenance tool is a door wedge tool having a rectangular portion;
said chamber is rectangular to receive said rectangular portion of said door wedge tool; and
said second elevator maintenance tools include each of a pen, a marker, a screwdriver, and a flashlight.
